(19) United States
(12) Patent Application Publication
(10) Pub. No.: US 2006/0170679 A1
(43) Pub. Date: Aug. 3, 2006

(54) Representing a volume of interest as boolean combinations of multiple simple contour sets

(76) Inventors: Hongwu Wang, Milpitas, CA (US); Jay B. West, Mountain View, CA (US); John R. Dooley, Castro Valley, CA (US)

Correspondence Address: ACCURAY/BLAKELY, 12400 WILSHIRE BOULEVARD, SEVENTH FLOOR, LOS ANGELES, CA, 90025-1030, US

(21) Appl. No.: 11/049,501

(22) Filed: Feb. 1, 2005

(51) Int. Cl. G06T 17/00

(52) U.S. Cl. 345/424

(57) ABSTRACT

An apparatus and method of representing a volume of interest as Boolean combinations of multiple simple contour sets.

### TECHNICAL FIELD

This invention relates to the field of medical devices and, in particular, to contour sets describing a volume of interest.

### BACKGROUND

Traditionally, medical imaging was used to represent two-dimensional views of the human anatomy. Modern anatomical imaging modalities such as computed tomography (CT) are able to provide an accurate three-dimensional model of a volume of interest (e.g., skull or tumor bearing portion of the body) generated from a collection of CT slices and, thereby, the volume requiring treatment can be visualized in three dimensions. More particularly, in CT scanning numerous x-ray beams are passed through a volume of interest in a body structure at different angles. Then, sensors measure the amount of radiation absorbed by different tissues. As a patient lies on a couch, an imaging system revolves around the patient emitting and recording x-ray beams from multiple points. A computer program is used to measure the differences in x-ray absorption to form cross-sectional images, or “slices” of the head and brain. These slices are called tomograms, hence the name “computed tomography.”

A volume of interest (VOI) may be defined as a set of planar, closed polygons, as illustrated in FIG. 1A. The coordinates of the polygon vertices are defined as the x/y/z offsets in a given unit from the image origin. Once a VOI has be defined, it may be represented as a bit wise mask overlaid on the image, so that each bit is zero or one according to whether the corresponding image volume pixel (voxel) is contained within the VOI represented by that bit.

Conventional VOI imaging architectures utilize a three-tier representation structure: VOI-contourslice-contour. FIG. 1B illustrates the three-tier VOI structure in a Unified Modeling Language (UML) graph with a sample VOI. In conventional VOI imaging architectures, a single contour slice may be restricted so that it contains only a simple (i.e. closed boundary with no holes or intersections) contour. If this restriction is present, contour slices may be created in non-adjacent slices, and interpolation used to create the contours in the intermediate slices. One drawback with such an architecture is that a single contour per slice design makes the following types of VOI difficult to define: a VOI that has branches, a VOI that has cavities inside of it, a VOI that has multiple unconnected bodies.

Alternatively, some conventional VOI imaging architectures allow multiple contours to be defined for each contour slice. In this case, VOIs with cavities, branches, and unconnected bodies may be drawn. However, in this case, it is often impossible to perform interpolation without manually labeling on each slice, which contours belong to which part of the structure, thus requiring a large amount of user interaction.

Another problem with conventional architectures is that it may be difficult to achieve conformality when using such architectures for inverse planning in stereotactic radiosurgery. In stereotactic radiosurgery, a collimated radiation source is positioned in a sequence calculated to localize the radiation dose into a VOI that as closely as possible conforms to that requiring treatment, while avoiding exposure of nearby healthy tissue. The degree to which such is achieved is referred to as conformality. Specifically, conformality is a measure of the amount of prescription (Rx) dose (amount of dose applied) within a target volume. Conformality may be measured using a conformality index (CI)=total volume at>=Rx dose/target volume at>=Rx dose. Perfect conformality results in a CI=1. With conventional radiotherapy treatment, using a treatment planning tool, a clinician identifies a contour for a corresponding VOI for application of a treatment dose (e.g., 2000 cGy), as illustrated in FIG. 1C. The identified contour is the same size as the treatment area (e.g., tumor). There is no easy way to use conventional methods of constraining the dose to tissue immediately surrounding, but not part of, the tumor.

One solution to the above noted problems is to create a pseudo cavity contour by deforming a solid contour into an elongated shape having ends and wrapping its ends around to form a structure illustrated in FIG. 1D. The resulting structure may be referred to as pseudo cavity because a gap resides between the ends of the deformed solid contour. One drawback of such a solution is that it is only an approximation of the cavity, and it must be drawn manually, often requiring a great deal of user effort.

### BRIEF DESCRIPTION OF THE DRAWINGS

The present invention is illustrated by way of example, and not by way of limitation, in the figures of the accompanying drawings.

FIG. 1A illustrates a volume of interest defined by a stack of planar closed polygons.

FIG. 1B illustrates a conventional three-tier VOI structure in a Unified Modeling Language (UML) graph with a sample VOI.

FIG. 1C illustrates a conventional treatment planning scheme.

FIG. 1D illustrates a pseudo cavity contour.

FIG. 2 illustrates one embodiment of a VOI architecture using a four-tier structure in a UML graph with an example VOI.

FIG. 3 illustrates one embodiment of a method of merging contour sets.

FIG. 4 illustrates a VOI with a corresponding overlaid bit wise mask.

FIG. 5 is a flowchart illustrating one embodiment of a method of generating a VOI mask volume.

FIG. 6 illustrates one embodiment of a table mapping between DICOM™ tags and VOI properties.

FIG. 7 illustrates of medical diagnostic imaging system implementing one embodiment of the present invention.

FIGS. 8a-8c illustrate one embodiment of a method of inverse planning.

FIG. 9 illustrates one method of creating a boundary critical structure.

### DETAILED DESCRIPTION

In the following description, numerous specific details are set forth such as examples of specific systems, components, methods, etc. in order to provide a thorough understanding of the present invention. It will be apparent, however, to one skilled in the art that these specific details need not be employed to practice the present invention. In other instances, well-known components or methods have not been described in detail in order to avoid unnecessarily obscuring the present invention.

Embodiments of the present invention include various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

Embodiments of the present invention may be provided as a computer program product, or software, that may include a machine-readable medium having stored thereon instructions, which may be used to program a computer system (or other electronic devices) to perform a process. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or other type of medium suitable for storing electronic instructions.

Embodiments of the present invention may also be practiced in distributed computing environments where the machine-readable medium is stored on and/or executed by more than one computer system. In addition, the information transferred between computer systems may either be pulled or pushed across the communication medium connecting the computer systems, such as in a remote diagnosis or monitoring system. In remote diagnosis or monitoring, a user may utilize embodiments of the present invention to diagnose or monitor a patient despite the existence of a physical separation between the user and the patient.

Some portions of the description that follow are presented in terms of algorithms and symbolic representations of operations on data bits that may be stored within a memory and operated on by a processor. These algorithmic descriptions and representations are the means used by those skilled in the art to effectively convey their work. An algorithm is generally conceived to be a self-consistent sequence of acts leading to a desired result. The acts are those requiring manipulation of quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, parameters, or the like.

A contour based method for representing a VOI is described. In this method, a contour set is used as the basic unit for representing a VOI. A contour set is composed of multiple contours defined on several image slices, with no more than one contour in any single slice. Each contour within a set is defined in the same image plane (axial, sagittal, or coronal). In order to define a VOI, a series of Boolean operators is used to merge the contour sets describing the VOI. For example, where the contour contains a cavity (a.k.a., hole), two contour sets may be developed using Boolean “AND” operators: one contour set for the cavity and one contour set for the surrounding VOI structure. The surrounding VOI as a contour set is merged with the contour set forming the boundary of the cavity using the Boolean “NOT” operator. By using Boolean “AND” and “NOT” operators, a VOI having multiple structures and cavities within each slice can be represented. In one embodiment, the merged contour sets do not all need to be in the same plane as each other. For example, a solid region defined in the axial direction may be merged with a cavity defined in the sagittal direction.

It should be noted that the methods and apparatus are discussed herein in relation to CT imaging only for ease of explanation. The method and apparatus discussed herein may also be used to represent VOIs with other types of medical diagnostic imaging systems, for example, magnetic resonance imaging (MR), ultrasound (US), nuclear medicine (NM) PET/SPECT systems, etc.

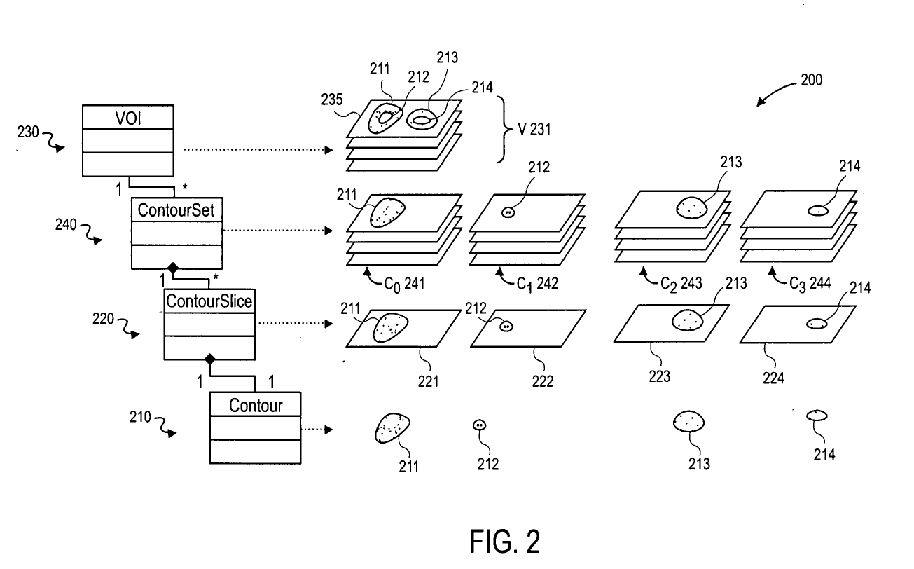

FIG. 2 illustrates one embodiment of a VOI architecture using a four-tier structure in a UML graph with an example VOI. UML is a graphical language for visualizing, specifying, constructing and documenting artifacts of a software-intensive system. The UML offers a standard way to write programming language statements, database schemas, and software components. UML is well known in the art; accordingly, a more detailed discussion is not provided herein.

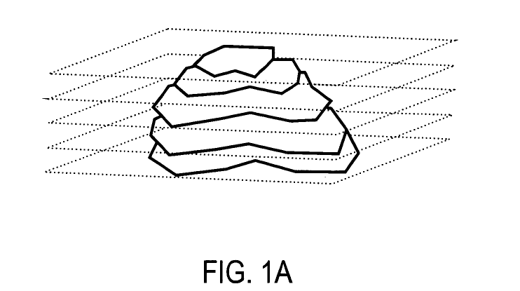

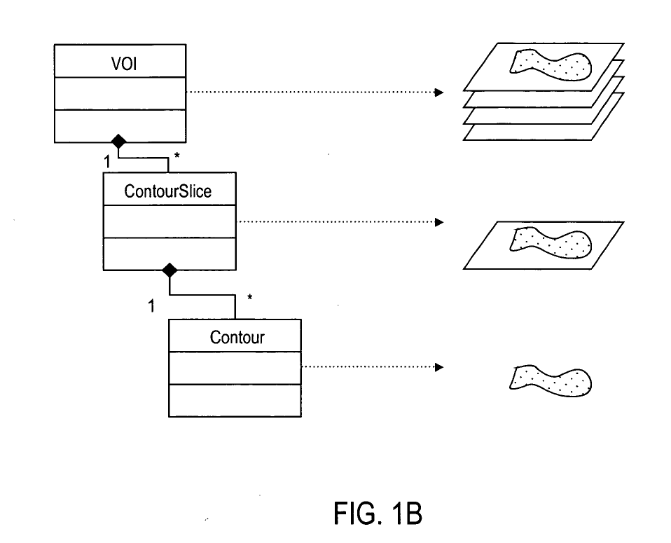

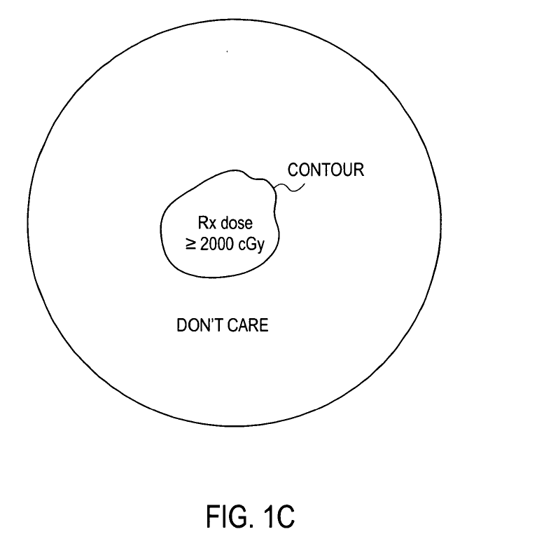

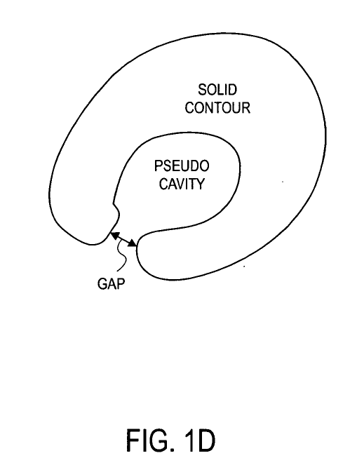

The VOI architecture 200 expands the conventional three-tier VOI architecture to a four-tier architecture. VOI architecture 200 includes a contour tier 210, a contour slice tier 220, a VOI tier 230 and a contour set tier 240. FIG. 2 provides an illustrative example of architecture 200 having with multiple bodies represented by four contour sets 241-244, four contour slices 221-224 and four contours 211-214. The additional contour set tier 240 is utilized between the VOI 231 and the contour slice tier 220, thereby enabling each VOI 231 to have more than one contour set. The use of multiple contour sets (e.g., contour sets 241-244) allows for multiple contour slices (e.g., contour slices 221-224, respectively) to be defined in one VOI image slice 235. An advantage of architecture 200 is that it can function with existing user interfaces and VOI contouring tools because one contour set (e.g., one of contour sets 241-244) is geometrically compatible to one VOI in the conventional three-tier architecture of FIG. 1B. It should be noted again that the architecture 200 is illustrated with four contour sets, four contour slices, and four bodies only for ease of discussion purposes and is not so limited. Architecture 200 may operate with other numbers of contours and corresponding contour slices and contour sets.

Using architecture 200, a region of interest (ROI) such as VOI image slice 235, can be represented as a Boolean combination of the multiple contour sets 241-244. Each of the contour sets 241-244 is composed of multiple contours defined on multiple image slices, with no more than one contour in any single slice. For example, contour set 241 includes contour slice 221 having a single contour 211. In one embodiment, each contour within a set may be defined in the same image plane (axial, sagittal, or coronal). Each contour within a set may be constructed by identification on a corresponding image slice or through interpolation from other contours on other image slices. It should be noted that interpolation techniques are well known in the art; accordingly, a detailed discussion is not provided herein.

In order to define VOI 231, a series of Boolean operators is used to merge the contour sets 241-244 describing the VOI 231. In one embodiment, contour sets 241-244 may be classified into two different types based on their geometric property: solid and cavity. A solid contour set (e.g., contour sets 241 or 243) represents voxels that exists in an image. While a cavity contour set (e.g., contour sets 242 or 244) represents voxels that need to be removed from a solid contour set. Having multiple contour sets in one VOI 231 may not be sufficient to represent a VOI 231 that contains cavity inside (e.g., cavity 212 or 214). As such, a Boolean operation is performed on the contour sets 241-244 to define such a VOI 231. In this embodiment, VOI 231 contains two bodies B₀) and B₂ that are defined by two contour sets: contour set 241 (C₀) and contour set 243 (C₂). In one embodiment, B₀ and B₂ may be unconnected bodies. The VOI (V) 231 may then be represented by using the Boolean OR operator (∪):
V=C₀∪C₂ (1)

If a VOI contains one solid body (C_{B}) that has a cavity (C_{C}) inside, then the VOI could be represented suing the Boolean AND operator (∩): V=C_{B}∩\overline{C_{C}} . . . In the embodiment illustrated in FIG. 2, the solid bodies B₀ and B₂, defined by a contour sets 241 (C₀) and contour set 243 (C₂), each have a cavity inside, defined by contour set 242 (C₁) and contour set 244 (C₃), respectively. It should be noted that the solid bodies are illustrated and discussed with single cavities therein only for ease of explanation, and the methods discussed herein may be used with solid bodies having multiple cavities therein.

The VOI 231 may then be represented by using the Boolean NOT operator:
V=(C₀∪C₂)∩(\overline{C₁∪C₃}) (2)

In general, with a VOI (V) that contains N contour sets, C₀ . . . C_{N-1}, if the first K contour sets are of a solid type, and the rest of the contour sets are of a cavity type, the final geometry of the VOI could be represented as:
V=(C₀∪C₁∪ . . . ∪C_{K-1})∩\overline{C}_{K}∩\overline{C}_{K+1}∩ . . . ∩\overline{C}_{N-1} (3)
=(C₀∪C₁∪ . . . ∪C_{K-1})∩(\overline{C_{K}∪C_{K+1}520 . . . ∪C_{N-1}}) (4)

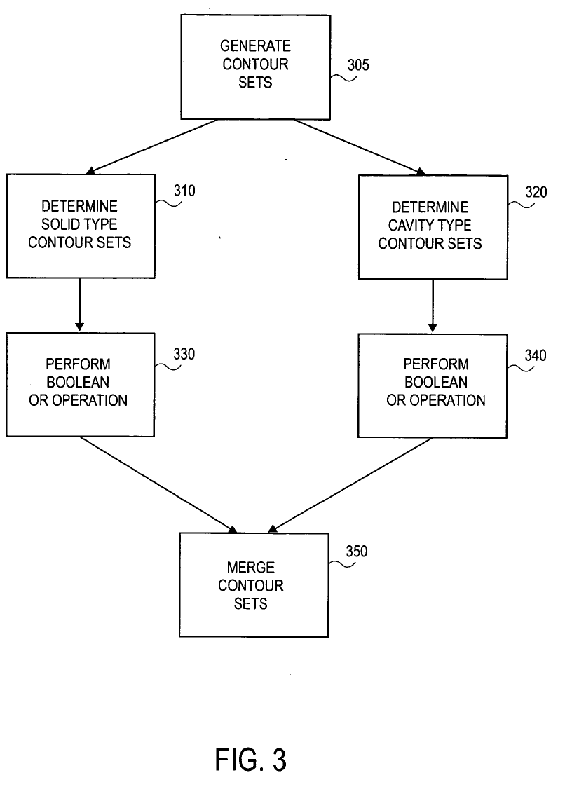

FIG. 3 illustrates a method of merging the contour sets 241-245 using the Boolean AND and NOT operates as discussed above. In step 305, the contour sets are generated. In step 310, determine which contour sets are of a solid type. In step 320, determine which contour sets are of a cavity type. It should be noted that the determination of the cavity contour sets of step 320 may be performed after, prior to, or concurrent with the determination of the solid contour sets of step 310.

After the determination of the solid and cavity type contour sets, a Boolean OR operation is performed on all solid contour sets, step 330, and a Boolean OR operation is performed on all cavity contour sets, step 340. It should be noted that the Boolean OR operation performed on all cavity contour sets of step 340 may be performed after, prior to, or concurrent with the Boolean OR operation performed on all solid contour sets of step 330. In step 350, the Boolean OR'd solid contour sets are merged with the Boolean OR'd cavity contour sets by taking the OR'd solid contour sets and Boolean AND'ing them with a Boolean NOT of the OR'd cavity contour sets according to equation (4) above.

It should be noted that the merged contour sets do not all need to be in the same plane as each other. Some anatomical locations are much better viewed in one plane than another. As such, it may be desirable to utilize images taken in different planes. Using the method discussed above with respect to FIG. 3, a solid contour set for a body imaged in one (e.g., axial) direction may be merged with a solid and/or cavity contour set defined imaged in a different (e.g., sagittal) direction. In addition, the Boolean operations discussed above may also be used to define a VOI having a branch. As such, in an alternative embodiment, B₀ and B₂ may represent branches of a larger connected body in the Vol.

It should be noted that with a conventional 3-tier architecture, VOl editing user interface and contouring tools operate directly on a current selected VOl. With the 4-tier architecture 200 of FIG. 2, a contour set could be viewed as a VOl in the conventional 3-tier architecture. Therefore, a “current selected contour set” option may be added to existing user interfaces and contouring tools with all the operations which were previously sent to a VOl redirected to the “current selected contour set” of the current selected VOl. In one embodiment, for example, architecture 200 may be implemented with, for example, the PMOS Volume-of-Interest tool available from PMOD technologies Ltd. of Zurich, Switzerland. Alternatively, other contouring tools may be used.

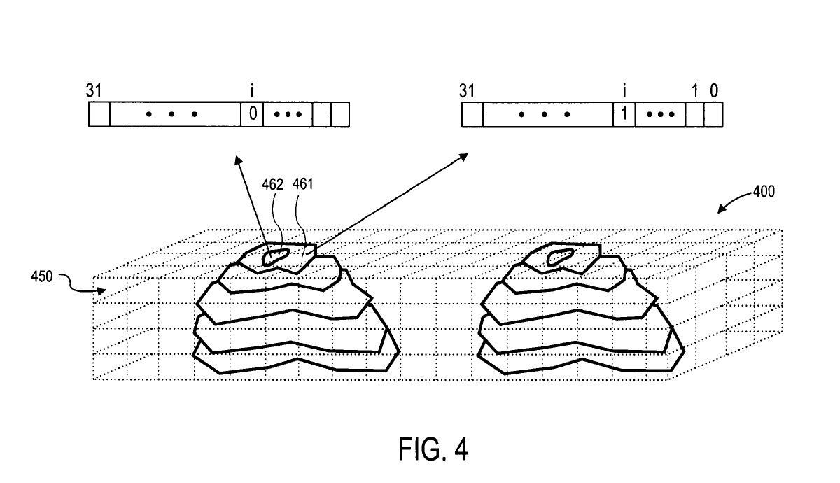

In one embodiment, after VOl 231 has be defined using architecture 200, it may be represented as a bit wise mask overlaid on the image, so that each bit is zero or one according to whether the corresponding image voxel is contained within the VOl represented by that bit, as illustrated in FIG. 4. FIG. 4 illustrates a VOl with a corresponding overlaid bit wise mask. The VOI mask volume 400 is a volume representation of all user defined VOIs that is geometrically considered as a cuboid composed of many small cuboids of the same size (i.e., the voxels). In this embodiment, every voxel (e.g., voxels 450, 462, 461, etc.) contains 32 bits. Alternatively, other number of bit words may be used for a voxel. Each bit of a voxel represents if the voxel is covered by a VOI that is defined by the index of the bit. For example, the bit for mask position 461 may be set to a “1” indicating that the corresponding image voxel is contained within the VOI represented by that mask position. While, the bit for mask position 462 may be set to a “0” indicating that the corresponding image voxel is not contained within the VOI represented by that mask position. The VOI mask volume serves as an interface between the VOI structures and the rest of the imaging system functions such as, for examples, a dose calculation algorithm and a 3-D VOI visualization.

In the 4-tier structure of architecture 200, all contour sets (e.g., contour sets 241-244) of a single VOI (e.g., VOI 231) share the same VOI index, which maps to a single mask bit index in the VOI mask volume 400. Therefore, anything that was based on VOI mask volume in a conventional architecture sees the same single mask plane for each VOI. The internal structure of the VOI is transparent to other algorithms and sub systems. Thus, the addition of the tier 240 in architecture 200 should not affect planning (e.g., dose calculation) and 3D visualization. Inside the VOI, a conventional VOI mask generation algorithm has to be expanded to support the VOI architecture 200 structure.

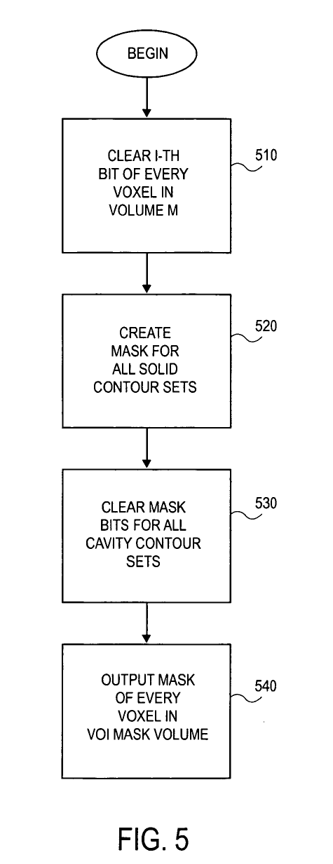

FIG. 5 is a flowchart illustrating one embodiment of a method of generating a VOI mask volume. In. this embodiment, the method of generating a VOI mask for a VOI that has a plurality of contour sets is described. The input VOI contains N contour sets C₀ to C_{N-1}, where the first K(K>0) contours sets are solid type contour sets and the rest of the contour sets are cavity type contour sets. In the flowchart of FIG. 5, I is the mask bit index of the VOI V (i.e., the bit that is currently being worked on) and M is the VOI mask volume. The output is a mask in the I-th bit of every voxel of the mask volume V.

The method begins at step 510 by clearing the I-th bit of every voxel in volume M. Then, in step 520, a mask is created for all solid contour sets. In particular, for each voxel P that belongs to the VOI mask volume M, if the voxel P belongs to a solid contour set then set the I-th mask bit of voxel P to logic 1.

In step 530, the mask bits for all cavity contour sets are cleared. In particular, for each voxel P that belongs to the VOI mask volume M, if the voxel P belongs to a cavity contour set then set the I-th mask bit of voxel P to logic 0. In step 540, a mask value in the I-th bit of every voxel of the mask volume V is output. It should be noted that in an alternative embodiment, the logic levels corresponding to a solid contour set and a cavity contour set may be switched.

In one embodiment, the above described method of generating a VOI mask volume may be implemented using the following VOI mask volume generation algorithm (with reference to the method steps of FIG. 5):

Inputs:

V(C₀, . . . C_{N-1}): Input VOI, which contains N contour sets: C₀ . . . , C_{N-1}, where the first K(K>0) contour sets have solid type; and the rest of the contour sets are cavity type.
I: mask bit index of VOI V.
M: VOI mask volume
   Output:
Mask in the I-th bit of every voxel of the mask volume M.
   Begin:
Clear the I-th bit of each voxel in volume M (step 510).

Create mask for all solid contour sets (step 520):

For each Cᵢ : Cᵢ ∈ V, 0 <= i < K
{

For each voxel P: P ∈ M
{

If P ∈ Cᵢ

Set the I-th mask bit of voxel of M at P to 1
}

}

Clear mask bits for all cavity contour sets (step 530):

For each Cᵢ : Cᵢ ∈ V, K <= i < N
{

For each voxel P: P ∈ M
{

If P ∈ Cᵢ

Set the I-th mask bit of voxel of M at P to 0

}

}

End

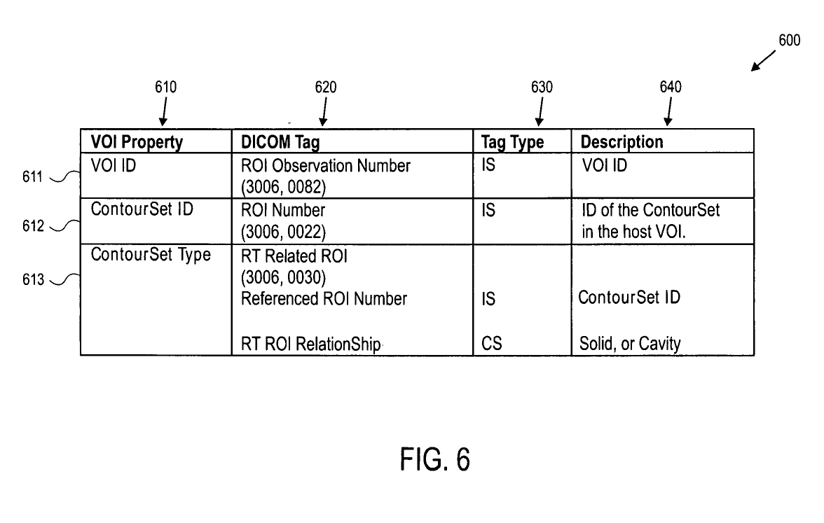

FIG. 6 illustrates one embodiment of a table mapping between DICOM™ tags and VOI properties. DICOM, which stands for Digital Imaging and Communications in Medicine, is the registered trademark of the National Electrical Manufacturers Association for its standards publications relating to digital communications of medical information (hereinafter referred to as DICOM standard). The DICOM standard was created to aid the distribution and viewing of medical images, such as CTs, MRIs, and ultrasound. More specifically, the DICOM standard facilities interoperatability of medical imaging equipment by specifying a set of protocols, along with commands and associated information that can be exchanged using these protocols, to be followed by devices claiming conformance to the standard. For devices to interact, there must be standards on how devices are expected to react to commands and associated data, not just the information that is to be moved between devices. As such, in one embodiment, VOI architecture 200 is made to be compliant with DICOM standard devices. Part 3 of the DICOM standard pertains to information object definitions. The information object definitions include a tag that is a unique identifier for an attribute of an information object composed of an order pair of numbers.

In order to be able to export the VOI architecture 200 structure to a DICOM standard format, the following information is mapped to DICOM standard tags:
(a) VOI ID: ID of the VOI, [0, N-1], where N is the maximum number of VOI.
(b) ContourSet ID: ID of ContourSet in a VOI, [0, M-1], where M is the maximum number of ContourSet in one VOI.
(c) ContourSet Type: Type of the ContourSet, [Solid, Cavity].

The mapping between the DICOM tags and the VOI properties is listed in the table 600 of FIG. 6. Table 600 includes VOI Property column 610, DICOM tag column 620, Tag Type column 630, and Description column 640. The VOI property column 610 includes three VOI properties: VOI ID 611, ContourSet ID 612, and ContourSet Type 613. Each of the VOI properties has a corresponding DICOM Tag, Tag Type and Descriptor as shown in table 600. In this embodiment, the three DICOM tags shown in table 600 are chosen to store the above information: (3006,0082), (3006,0022) and (3006,0030). In particular, the VOI ID is mapped to DICOM standard tag (3006,0082), the ContourSet ID is mapped to DICOM standard tag (3006,0022) and the ContourSet Type is mapped to DICOM standard tag (3006,0030). Alternatively, other DICOM tags may be chosen to store the above information.

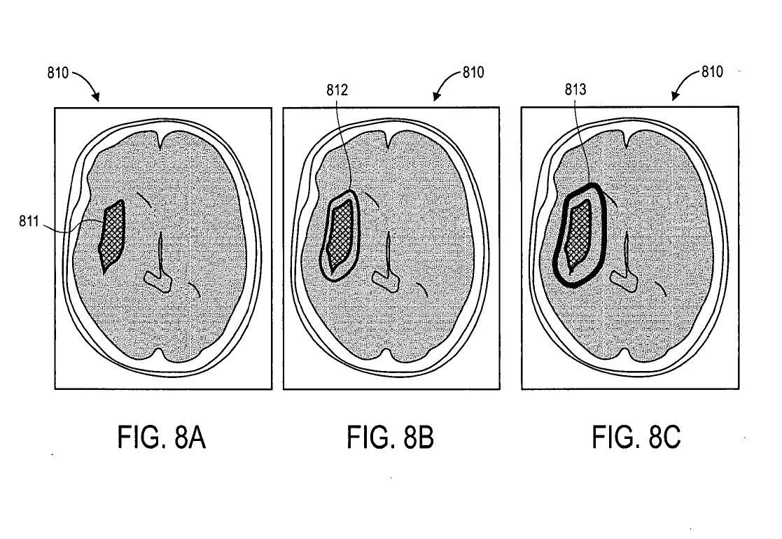

The multiple contour set VOI architecture 200 provides an improvement over the conventional architecture. Many applications, which are impossible in the conventional architecture, can be done implemented with architecture 200. One such application involves inverse planning as discussed below with respect to the illustration of FIG. 8.

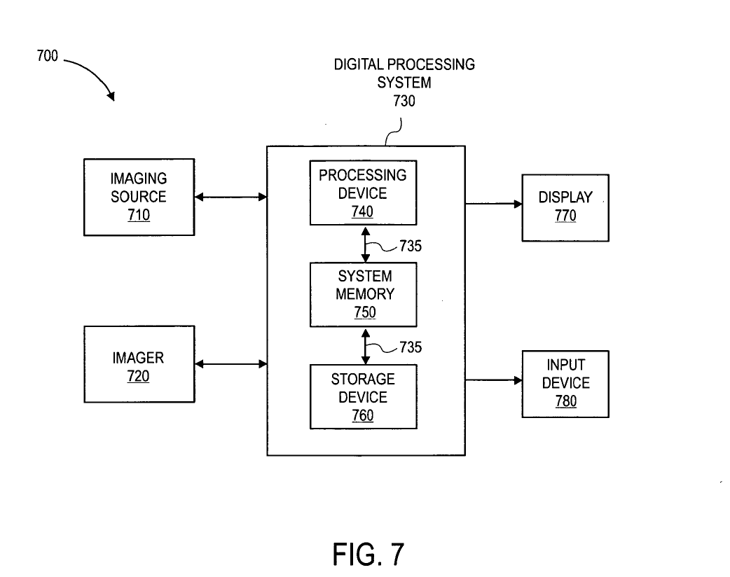

FIG. 7 illustrates one embodiment of medical diagnostic imaging system in which features of the present invention may be implemented. The medical diagnostic imaging system may be discussed below at times in relation to CT imaging modality only for ease of explanation. However, other imaging modalities may be used as previously mentioned.

Medical diagnostic imaging system 700 includes an imaging source 710 to generate a beam (e.g., kilo voltage x-rays, mega voltage x-rays, ultrasound, MRI, etc.) and an imager 720 to detect and receive the beam generated by imaging source 710. In an alternative embodiment, system 700 may include two diagnostic X-ray sources and/or two corresponding image detectors. For example, two x-ray sources may be nominally mounted angularly apart (e.g., 90 degrees apart or 45 degree orthogonal angles) and aimed through the patient toward the imager(s). A single large imager, or multiple imagers, can be used that would be illuminated by each x-ray imaging source. Alternatively, other numbers and configurations of imaging sources and imagers may be used.

The imaging source 710 and the imager 720 are coupled to a digital processing system 730 to control the imaging operation. Digital processing system 730 includes a bus or other means 735 for transferring data among components of digital processing system 730. Digital processing system 510 also includes a processing device 740. Processing device 740 may represent one or more general-purpose processors (e.g., a microprocessor), special purpose processor such as a digital signal processor (DSP) or other type of device such as a controller or field programmable gate array (FPGA). Processing device 740 may be configured to execute the instructions for performing the operations and steps discussed herein. In particular, processing device 740 may be configured to execute instructions to perform the Boolean operations on the contour sets 241-244 to define VOI 231 as discussed above with respect to FIG. 3 and to generate a VOI mask volume as discussed above with respect to FIG. 5.

Digital processing system 730 may also include system memory 750 that may include a random access memory (RAM), or other dynamic storage device, coupled to bus 735 for storing information and instructions to be executed by processing device 740. System memory 750 also may be used for storing temporary variables or other intermediate information during execution of instructions by processing device 740. System memory 750 may also include a read only memory (ROM) and/or other static storage device coupled to bus 735 for storing static information and instructions for processing device 740.

A storage device 760 represents one or more storage devices (e.g., a magnetic disk drive or optical disk drive) coupled to bus 735 for storing information and instructions. Storage device 760 may be used for storing instructions for performing the steps discussed herein.

Digital processing system 730 may also be coupled to a display device 770, such as a cathode ray tube (CRT) or liquid crystal display (LCD), for displaying information (e.g., 3D representation of the VOI) to the user. An input device 780, such as a keyboard, may be coupled to digital processing system 730 for communicating information and/or command selections to processing device 740. One or more other user input devices, such as a mouse, a trackball, or cursor direction keys for communicating direction information and command selections to processing device 740 and for controlling cursor movement on display 770 may also be used.

It will be appreciated that the digital processing system 730 represents only one example of a system, which may have many different configurations and architectures, and which may be employed with the present invention. For example, some systems often have multiple buses, such as a peripheral bus, a dedicated cache bus, etc.

FIGS. 8a-8c illustrate one embodiment of a method of inverse planning. In stereotactic radiosurgery, an accurate three-dimensional model of the skull or other tumor bearing portion of the body is generated from thin-cut CT scans, thus the volume requiring treatment can be visualized in three dimensions. Unlike conventional radiation therapy treatment planning where the beam selection and does is define by the user, in inverse planning, the system user may outline treatment volumes and critical structures on the CT images and prescribe a dose accordingly. The treatment planning system then selects a beam configuration (e.g., direction, distance, number and energy of beams for treatment) and generates a plan. A collimated radiation source is positioned in a sequence calculated by the plan to localize the energy deposition into a VOI that as closely as possible conforms to that requiring treatment, while avoiding exposure of nearby healthy tissue. The dose distribution is an important parameter in stereotactic surgery. If a radiation dose were too low due to unforeseen conditions at a point intended to receive the maximum radiation, then the surgery could be ineffective. If a radiation dose were too high at a particular point in the tissue, the surgery might have negative effects. As such, it is desirable to be able to form constraints on an inverse planning system in such a way that conformality of dose to the treatment target is rewarded such that the treatment target will result in a dose distribution within the prescribed limits and damage to healthy tissue is minimized.

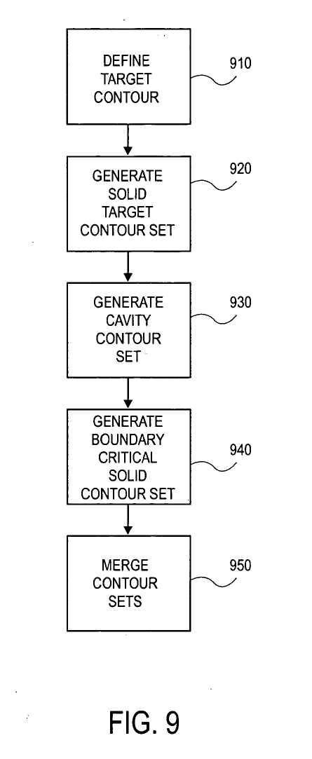

This may be achieved by using the multiple contour set VOI architecture 200, as discussed below in relation to the exemplary brain CT images of FIGS. 8a-8c and the method flow chart of FIG. 9. FIGS. 8a-8c show an example of a brain CT image 810. A target contour 811 is generated for the target ROI to receive a prescription dose (e.g., 2000 cGy). Target, solid contour 811 describes treatment target to receive a desired prescription dose to be constrained therein. A first contour set is generated corresponding to target volume, identified in one image slice by contour 811. The treatment target contour is dilated (or otherwise generated) to create a cavity contour 812 (with respect to the solid contour 813 defined below), with a corresponding second contour set generated for the cavity identified by contour 813. The cavity contour may be dilated (or otherwise generated) to generate a third (solid) contour 813, with a corresponding solid contour set generated for the solid identified by contour 813. The solid contour set together with the cavity contour set, forms a boundary critical structure that is a shell VOI of arbitrary thickness around the target. The maximum dose may then be constrained within this structure. The boundary critical, solid contour set may be merged with the cavity contour set in the manner using the methods discussed above with respect to FIG. 3 in order to represent the VOI containing the boundary critical structure.

FIG. 9 illustrates one method of creating a boundary critical structure. In one embodiment, at step 910, a target contour 811 is defined and a solid type target contour set is generated for the target VOI (e.g., by defining a target ROI on two or more CT image slices and using software to extrapolate a target VOI), step 920.

In step 930, the contour set for the target VOI is copied to a new critical structure contour set and the new contour set is dilated in all directions by a certain amount (e.g., 5 mm), or otherwise generated (e.g., by manual tracing), illustrated by contour 812, to create a cavity type contour set. In step 940, the dilated cavity contour set is copied to a new contour set and, itself, dilated in all directions by a certain amount (e.g., 5 mm), or otherwise generated, (illustrated by the contour 813 to created a boundary critical, solid type contour set. The resulting boundary critical structure is defined by the inner contour 812 and the outer contour 813. In step 950, the contour sets are then merged. In particular, a Boolean “NOT” of the cavity contour set (corresponding to contour 812) is Boolean AND'd with the third, solid contour set (corresponding to contour 813) to create a shell VOI of arbitrary thickness around the target body represented in one image slice by contour 811. The inverse planning procedure discussed above can impose a high dose gradient at the edges of the target, thus increasing conformality.

It should be noted that the methods and apparatus described herein are not limited to use only in with medical diagnostic imaging. In alternative embodiments, the methods and apparatus herein may be used outside of the medical technology field, such as non-destructive testing of materials (e.g., motor blocks in the automotive industry and drill cores in the petroleum industry) and seismic surveying.

In the foregoing specification, the invention has been described with reference to specific exemplary embodiments thereof. It will, however, be evident that various modifications and changes may be made thereto without departing from the broader spirit and scope of the invention as set forth in the appended claims. The specifications and drawings are, accordingly, to be regarded in an illustrative sense rather than a restrictive sense.

What is claimed is:

1. A volume of interest (VOI) architecture defining a plurality of medical image slices, the architecture comprising a four-tier structure.

2. The architecture of claim 1, wherein one tier of the four-tier structure comprises:
a plurality of contour sets, each of the plurality of contour sets having a different contour defined on the plurality of image slices, with no more than one contour in any one of the plurality of image slices.

3. The architecture of claim 2, wherein the plurality of contour sets comprises:
a solid contour set comprising a first contour corresponding to voxels that exist in an image slice; and
a cavity contour set comprising a second contour corresponding to voxels that do not exist in an image slice.

4. The architecture of claim 3, wherein the cavity contour set represents voxels that are to be removed from the solid contour set.

5. The architecture of claim 1, wherein one tier of the four-tier structure comprises a plurality of defined contours per image slice.

6. The architecture of claim 2, wherein each contour with a contour set is defined in a same image plane.

7. The architecture of claim 2, wherein one of the plurality of contour sets is geometrically compatible to one VOI.

8. A method of representing a volume of interest, comprising:
generating a first contour set and a second contour set, each of the first and second contour sets having a different, single contour; and
merging the first contour set and the second contour set using Boolean operators.

9. The method of claim 8, wherein merging comprises using a Boolean AND operator and a Boolean NOT operator.

10. The method of claim 8, wherein merging comprises performing a Boolean AND operation on the first contour set with a Boolean NOT of the second contour set.

11. The method of claim 8, wherein the first contour set includes a first contour defining a solid body and wherein the second contour set includes a second contour defining a cavity within the solid body.

12. The method of claim 11, wherein merging comprises performing a Boolean AND operation on the first contour set with a Boolean NOT of the second contour set.

13. The method of claim 8, wherein the first contour set is in a first plane being different than a second plane of the second contour set.

14. The method of claim 12, wherein the first contour set defining a solid body is in a first plane being different than a second plane of the second contour set.

15. The method of claim 14, wherein the first plane is in an axial direction and the second plane is in a sagittal direction.

16. A machine readable medium having instructions stored thereon, which when executed by a processor, cause the processor to perform the following comprising:
generating a first contour set and a second contour set, each of the first and second contour sets having a different, single contour; and
merging the first contour set and the second contour set using Boolean operators.

17. The machine readable medium of claim 16, wherein merging comprises using a Boolean AND operator and a Boolean NOT operator.

18. The machine readable medium of claim 16, wherein merging comprises performing a Boolean AND operation on the first contour set with a Boolean NOT of the second contour set.

19. The machine readable medium of claim 16, wherein the first contour set includes a first contour defining a solid body and wherein the second contour set includes a second contour defining a cavity within the solid body.

20. The machine readable medium of claim 19, wherein merging comprises performing a Boolean AND operation on the first contour set with a Boolean NOT of the second contour set.

21. The machine readable medium of claim 16, wherein the first contour set is in a first plane being different than a second plane of the second contour set.

22. The machine readable medium of claim 21, wherein the first contour set defining a solid body is in a first plane being different than a second plane of the second contour set.

23. A method of representing a volume of interest, comprising:
generating a first contour set including a first contour defining a first solid body;
generating a second contour set including a second contour defining a first cavity within the first solid body;
generating a third contour set including a third contour defining a second solid body;
generating a fourth contour set including a fourth contour defining a second cavity within the second solid body;
Boolean OR'ing the first and third contour sets to generate a first result;
Boolean OR'ing the second and fourth contour sets to generate a second result; and
Boolean AND'ing the first result with a Boolean NOT of the second result.

24. The method of claim 23, wherein the first and third contour sets defining the first and second solid bodies, respectively, are in a first plane being different than a second plane of the second and third contour sets defining the first and second cavities, respectively.

25. A machine readable medium having instructions stored thereon, which when executed by a processor, cause the processor to perform the following comprising:
generating a first contour set including a first contour defining a first solid body;
generating a second contour set including a second contour defining a first cavity within the first solid body;
generating a third contour set including a third contour defining a second solid body;
generating a fourth contour set including a fourth contour defining a second cavity within the second solid body;
Boolean OR'ing the first and third contour sets to generate a first result;
Boolean OR'ing the second and fourth contour sets to generate a second result; and
Boolean AND'ing the first result with a Boolean NOT of the second result.

26. The machine readable medium of claim 25, wherein the first and third contour sets defining the first and second solid bodies, respectively, are in a first plane being different than a second plane of the second and third contour sets defining the first and second cavities, respectively.

27. A method of generating a volume of interest (VOI) mask for a VOI that has a plurality of contour sets, comprising:
clearing a plurality of mask bits of a plurality of voxels of a mask volume;
creating a mask having the plurality of mask bits for a first contour set that include a first contour defining a solid body; and
clearing the plurality mask bits for a second contour set includes a second contour defining a cavity within the solid body.

28. The method of claims 27, wherein creating the mask comprises setting a first mask bit of one of the plurality of voxels to a first value when the first mask bit corresponds to the first contour set that includes the first contour defining the solid body.

29. The method of claims 28, wherein clearing comprises setting a second mask bit of one of the plurality of voxels to a second value, being different than the first value, when the second mask bit corresponds to the second contour set that includes the second contour defining the cavity within the solid body.

30. The method of claim 29, wherein the first value is a logic one and wherein the second value is a logic zero.

31. A machine readable medium having instructions stored thereon, which when executed by a processor, cause the processor to perform the following comprising:
clearing a plurality of mask bits of a plurality of voxels of a mask volume;
creating a mask having the plurality of mask bits for a first contour set that include a first contour defining a solid body; and
clearing the plurality mask bits for a second contour set includes a second contour defining a cavity within the solid body.

32. The machine readable medium of claim 31, wherein creating the mask comprises setting a first mask bit of one of the plurality of voxels to a first value when the first mask bit corresponds to the first contour set that includes the first contour defining the solid body.

33. The machine readable medium of claim 32, wherein clearing comprises setting a second mask bit of one of the plurality of voxels to a second value, being different than the first value, when the second mask bit corresponds to the second contour set that includes the second contour defining the cavity within the solid body.

34. An apparatus, comprising:
an imager to generate a plurality of image slices; and
a processor coupled to the imager to receive the plurality of image slices, the processor to generate a plurality of contour sets with each of the plurality of contour sets having a different contour defined on the plurality of image slices and with no more than one contour in any one of the plurality of image slices, the processor to define a volume of interest (VOI) using the plurality of contour sets.

35. The apparatus of claim 34, further comprising a storage device coupled to the processor to store the plurality of image slices.

36. The apparatus of claim 34, wherein the processor is configured to generate a first contour set and a second contour set of the plurality of contour sets, each of the first and second contour sets having a different, single contour, and merge the first contour set and the second contour set by performing a Boolean AND operation on the first contour set with a Boolean NOT of the second contour set.

37. The apparatus of claim 34, wherein the processor is configured to generate VOI mask for the VOI by clearing all mask bits of a plurality of voxels of a mask volume, setting a first mask bit of one of the plurality of voxels to a first value when the first mask bit corresponds to the first contour set that include a first contour defining a solid body, and setting a second mask bit of one of the plurality of voxels to a second value, being different than the first value, when the second mask bit corresponds to the second contour set that include a second contour defining a cavity within the solid body.

38. The apparatus of claim 34, further comprising a storage device coupled to the processor to store:
a first tag corresponding to a VOI identifier; and
a second tag corresponding to a contour set identifier;
a third tag corresponding to a contour set type identifier.

39. An apparatus for representing a volume of interest, comprising:
means for generating a first contour set and a second contour set, each of the first and second contour sets having a different, single contour; and
means for merging the first contour set and the second contour set using Boolean operators.

40. The apparatus of claim 39, wherein the means for merging comprises means for performing a Boolean AND operation on the first contour set with a Boolean NOT of the second contour set.

41. The apparatus of claim 40, wherein the first contour set includes a first contour defining a solid body and wherein the second contour set includes a second contour defining a cavity within the solid body.

42. The apparatus of claim 40, wherein the means for merging further comprises means for merging the first contour set being a first plane different than a second plane of the second contour set.

43. The apparatus of claim 40, further comprising:
means for clearing all mask bits of a plurality of voxels of a mask volume;
means for setting a first mask bit of one of the plurality of voxels to a first value when the first mask bit corresponds to the first contour set; and
means for setting a second mask bit of one of the plurality of voxels to a second value, being different than the first value, when the second mask bit corresponds to the second contour set.

44. A method, comprising:
mapping a volume of interest (VOI) identifier to a first DICOM standard tag;
mapping a contour set identifier to a second DICOM standard tag; and
mapping a contour set type identifier to a third DICOM standard tag.

45. The method of claim 44, wherein the first DICOM standard tag is a region of interest (ROI) observation number.

46. The method of claim 45, wherein the ROI observation number is (3006,0082).

47. The method of claim 44, wherein the second DICOM standard tag is a region of interest (ROI) number.

48. The method of claim 47, wherein the ROI number is (3006,0022).

49. The method of claim 44, wherein the third DICOM standard tag is a referenced region of interest (ROI) number.

50. The method of claim 49, wherein the referenced ROI number is (3006,0030).

51. A method of forming a boundary critical structure, comprising:
defining a target volume of interest (VOI) using a plurality of target contours, each of the plurality of target contours residing on a different image slice;
generating a target contour set using the plurality of target contours;
generating a cavity contour set from the plurality of target contours;
generating a boundary critical contour set from the plurality of target contour; and
merging the boundary critical contour set with the cavity contour set.

52. The method of claim 51, wherein generating the cavity contour set comprises:
dilating the plurality of target contours in all directions by a first distance to create a plurality of cavity contours; and
constructing the cavity contours set using the plurality of cavity contours.

53. The method of claim 52, wherein generating the boundary critical contour set comprises dilating the plurality of cavity contours in all directions by a second distance to create a plurality of boundary critical contours.

54. The method of claim 53, wherein merging comprises performing a Boolean AND operation on the boundary critical contour set with a Boolean NOT of the cavity contour set.
